(19) United States
(12) Patent Application Publication
(10) Pub. No.: US 2023/0082326 A1
(43) Pub. Date: Mar. 16, 2023

(54) TRAINING MULTI-OBJECTIVE NEURAL NETWORK REINFORCEMENT LEARNING SYSTEMS

(71) Applicant: DeepMind Technologies Limited, London (GB)

(72) Inventors: Abbas Abdolmaleki, London (GB); Sandy Han Huang, London (GB)

(21) Appl. No.: 17/797,203

(22) PCT Filed: Feb. 8, 2021
(86) PCT No.: PCT/EP2021/052986

§ 371 Date: Aug. 3, 2022

Related U.S. Application Data
(60) Provisional application No. 62/971,661, filed on Feb. 7, 2020.

(51) Int. Cl. G06N 3/08

(52) U.S. Cl. CPC G06N 3/08

(57) ABSTRACT

There is provided a method for training a neural network system by reinforcement learning, the neural network system being configured to receive an input observation characterizing a state of an environment interacted with by an agent and to select and output an action in accordance with a policy that aims to satisfy a plurality of objectives. The method comprises obtaining a set of one or more trajectories. Each trajectory comprises a state of an environment, an action applied by the agent to the environment according to a previous policy in response to the state, and a set of rewards for the action, each reward relating to a corresponding objective of the plurality of objectives. The method further comprises determining an action-value function for each of the plurality of objectives based on the set of one or more trajectories. Each action-value function determines an action value representing an estimated return according to the corresponding objective that would result from the agent performing a given action in response to a given state according to the previous policy. The method further comprises determining an updated policy based on a combination of the action-value functions for the plurality of objectives.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes methods for training a reinforcement learning system that selects actions to be performed by a reinforcement learning agent interacting with an environment. The methods can be used to train a reinforcement learning system which has multiple, potentially conflicting objectives.

In one aspect there is provided a method for training a neural network system by reinforcement learning, the neural network system being configured to receive an input observation characterizing a state of an environment interacted with by an agent and to select and output an action in accordance with a policy that aims to satisfy a plurality of objectives. The method comprises obtaining a set of one or more trajectories. Each trajectory comprises a state of an environment, an action applied by the agent to the environment according to a previous policy in response to the state, and a set of rewards for the action, each reward relating to a corresponding objective of the plurality of objectives. The method further comprises determining an action-value function for each of the plurality of objectives based on the set of one or more trajectories. Each action-value function determines an action value representing an estimated return according to the corresponding objective that would result from the agent performing a given action in response to a given state according to the previous policy. The method further comprises determining an updated policy based on a combination of the action-value functions for the plurality of objectives.

By determining separate action-value functions for each objective, the methods described herein are able to effectively balance competing objectives during reinforcement learning. The action-value functions overcome problems associated with determining the optimum weights when combining action values for separate objectives. Furthermore, the separate action-value functions provide scale-invariance with regard to the size of the rewards for each objective, thereby avoiding one or more of the objectives dominating the learning through the relative size of their rewards.

The set of one or more trajectories may be obtained from storage (i.e. may be previously calculated) or may be obtained by applying the agent to one or more states. The set of one or more trajectories may comprise a plurality of trajectories, thereby allowing batch learning. Alternatively, one trajectory may be provided per update as part of online learning.

It should be noted that whilst the term “reward” is discussed herein, these rewards may be negative. In the case of negative rewards, these may equally be considered costs. In this case, the overall objective of a reinforcement learning task would be to minimize the expected cost (instead of maximizing the expected reward or return).

In some implementations each action-value function provides a distribution of action values for a corresponding objective of the plurality of objectives across a range of potential state-action pairs for the previous policy. Each action-value function may output an action-value representing the expected cumulative discounted reward for the corresponding objective when choosing a given action in response to a given state. This cumulative discounted reward may be calculated over a number of subsequent actions, implemented in accordance with the previous policy. The action-value function for each objective may be considered an objective-specific action-value function.

In some implementations determining an updated policy comprises determining an objective-specific policy for each objective in the plurality of objectives. Each objective-specific policy may be determined based on the corresponding action-value function for the corresponding objective. The method may further comprise determining the updated policy by fitting a set of policy parameters of the updated policy to a combination of the objective-specific policies. The combination of the objective-specific policies may be a sum of the objective-specific policies. The objective specific policies are also referred to herein as action distributions (not to be confused with action-value functions) as they can provide a probability distribution of actions over states. In light of the above, the updated policy may be determined by combining action-value functions through a combination of objective-specific policies that have been derived from the action-value functions. The policy is then fitted to the combination of objective-specific policies.

By combining objectives through a combination of objective-specific policies, the methodology described herein combines the objectives in distribution space. This is in contrast to combining objectives in reward space (e.g. by transforming a multi-objective reward vector into a single scalar reward). By combining the objectives in distribution space, the combination is therefore invariant to the scale of the rewards. The relative contribution of each objective to the updated policy can be scaled through use of constraints on the determination of the objective-specific policies.

In some implementations fitting the set of policy parameters of the updated policy to the combination of the objective-specific policies comprises determining the set of policy parameters that minimizes a difference between the updated policy and the combination of the objective-specific policies.

The minimization of the difference between the updated policy and the combination of the objective-specific policies may be constrained such that a difference between the updated policy and the previous policy does not exceed a trust region threshold. In other words, the set of policy parameters for the updated policy may be constrained such that a difference between the updated policy and the previous policy cannot exceed the trust region threshold. The trust region threshold may be considered a hyperparameter that limits the overall change in the policy to improve stability of learning.

The differences between policies discussed herein may be calculated through use of the Kullback-Leibler (KL) divergence or any other appropriate measure of the difference between distributions.

In some implementations determining an objective-specific policy for each objective comprises determining objective-specific policy parameters for the objective-specific policy that increase the expected return according to the action-value function for the corresponding objective relative to the previous policy.

In some implementations determining the objective-specific policy for each objective comprises determining objective-specific policy parameters for the objective-specific policy that that maximize the expected return according to the action-value function for the corresponding objective relative to the previous policy, subject to a constraint that the objective-specific policy may not differ from the previous policy by more than a corresponding difference threshold. The difference between the objective-specific policy and the previous policy may be determined based on the Kullback-Leibler divergence or any other appropriate measure of the difference between distributions.

Accordingly, each objective-specific policy can be determined subject to a constraint that it does not differ from the previous policy by more than a corresponding difference threshold. The corresponding difference threshold may be considered to represent the relative contribution of the corresponding objective to the updated policy. Accordingly, the relative contribution of each objective to the updated policy may be adjusted by adjusting the corresponding difference threshold. That is, the relative weight between each objective is encoded in the form of constraints on the influence of each objective on the policy update.

In some implementations the objective-specific policies are non-parametric policies. This reduces the computational complexity with regard to determining the objective-specific policies whilst conforming to the constraints with regard to the corresponding difference thresholds. This is because the constrained optimization can be solved in closed form for each state.

Each objective-specific policy, qₖ(a|s), may be determined from a scaled action-value function for the objective of the objective-specific policy, wherein the scaled action-value function is scaled by a value dependent upon a preference for the objective. The value dependent upon a preference for the objective may be dependent on the difference threshold for the objective. The value dependent upon a preference for the objective may be a temperature parameter ηₖ dependent on the difference threshold.

For instance, each objective-specific policy, qₖ(a|s), may be determined by calculating:

$${q}_{k} ( a \vert s ) = N {π}_{old} ( a \vert s ) exp ( \frac{{Q}_{k} ( s , a )}{{η}_{k}} )$$

where:

N is a normalization constant;

k is the objective;

a is an action;

s is a state;

π_{old} (a|s) is the previous policy;

Qₖ(s, a) is the action-value function for the objective; and

ηₖ is a temperature parameter.

For each objective, k, the temperature parameter ηₖ may be determined by solving the following equation:

$${η}_{k} = {arg min}_{η} η {ϵ}_{k} + η {\int }_{s} μ ( s ) log {\int }_{a} {π}_{old} ( a \vert s ) exp ( \frac{{Q}_{k} ( s , a )}{η} ) da ds$$

where:

ϵₖ is the difference threshold for the corresponding objective; and

μ(s) is a visitation distribution.

Each temperature parameter may be determined via gradient descent.

In a further implementation there is provided a method for training a neural network system by reinforcement learning, the neural network system being configured to receive an input observation characterizing a state of an environment interacted with by an agent and to select and output an action in accordance with a policy that aims to satisfy a plurality of objectives. The method may comprise obtaining a set of one or more trajectories, each trajectory comprising a state of an environment, an action applied by the agent to the environment according to a previous policy in response to the state, and a set of rewards for the action, each reward relating to a corresponding objective of the plurality of objectives. The method may further comprise determining a probability distribution (such as an action distribution or a state-action distribution) for each of the plurality of objectives based on the set of one or more trajectories, each probability distribution providing a distribution of action probabilities that would increase the expected return according to a corresponding objective relative to the policy. The method may further comprise determining an updated policy based on a combination of the probability distributions for the plurality of objectives.

Determining a probability distribution for each of the plurality of objectives may comprise, for each objective: determining a value function defining a value representing an expected return according to the corresponding objective that would result from the agent following the previous policy from a given state; and determining the probability distribution for the objective based on the value function.

Each probability distribution may be a state-action distribution defining a distribution of probabilities of state-action pairs and the value function for each objective may be a state-value function defining a value representing an expected return according to the corresponding objective that would result from the agent following the previous policy from a given state. This may be applicable to on-policy learning.

Alternatively, each probability distribution may be an objective-specific policy (an action distribution) defining a distribution of probabilities of actions over states and the value function may be an action-value function representing an expected return according to the corresponding objective that would result from the agent performing a given action in response to a given state according to the previous policy. This may be applicable to off-policy learning.

The methods described herein may be implemented through one or more computing devices and/or one or more computer storage media.

In one aspect there is provided a system comprising one or more computers and one or more storage devices storing instructions that when executed by the one or more computers cause the one or more computers to perform the following operations: obtaining a set of one or more trajectories, each trajectory comprising a state of an environment, an action applied by the agent to the environment according to a previous policy in response to the state, and a set of rewards for the action, each reward relating to a corresponding objective of the plurality of objectives; determining an action-value function for each of the plurality of objectives based on the set of one or more trajectories, each action-value function determining an action value representing an estimated return according to the corresponding objective that would result from the agent performing a given action in response to a given state according to the previous policy; and determining an updated policy based on a combination of the action-value functions for the plurality of objectives.

In one aspect there is provided one or more computer storage media storing instructions that when executed by one or more computers cause the one or more computers to perform the following operations: obtaining a set of one or more trajectories, each trajectory comprising a state of an environment, an action applied by the agent to the environment according to a previous policy in response to the state, and a set of rewards for the action, each reward relating to a corresponding objective of the plurality of objectives; determining an action-value function for each of the plurality of objectives based on the set of one or more trajectories, each action-value function determining an action value representing an estimated return according to the corresponding objective that would result from the agent performing a given action in response to a given state according to the previous policy; and determining an updated policy based on a combination of the action-value functions for the plurality of objectives.

In order for the agent to interact with the environment, the system receives data characterizing the current state of the environment and selects an action to be performed by the agent in response to the received data. Data characterizing a state of the environment will be referred to in this specification as an observation.

In some applications the environment is a real-world environment and the agent is a mechanical agent interacting with the real-world environment. For example, the agent may be a robot interacting with the environment to accomplish a specific task. As another example, the agent may be an autonomous or semi-autonomous land or air or water vehicle navigating through the environment. In these implementations, the actions may be control inputs to control a physical behavior of the robot or vehicle.

In general the observations may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. For example in the case of a robot the observations may include data characterizing the current state of the robot, e.g., one or more of: joint position, joint velocity, joint force, torque or acceleration, and global or relative pose of a part of the robot such as an arm and/or of an item held by the robot. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these applications the actions may be control inputs to control the robot, e.g., torques for the joints of the robot or higher-level control commands; or to control the autonomous or semi-autonomous land or air or sea vehicle, e.g., torques to the control surface or other control elements of the vehicle or higher-level control commands; or e.g. motor control data. In other words, the actions can include for example, position, velocity, or force/torque/acceleration data for one or more joints of a robot or parts of another mechanical agent. Action data may include data for these actions and/or electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation e.g. steering, and movement e.g. braking and/or acceleration of the vehicle.

In these applications the objectives, and associated rewards/costs may include, or be defined based upon the following:
i) One or more rewards for approaching or achieving one or more target locations, one or more target poses, or one or more other target configurations. One or more rewards dependent upon any of the previously mentioned observations e.g. robot or vehicle positions or poses. For example in the case of a robot a reward may depend on a joint orientation (angle) or velocity, an end-effector position, a center-of-mass position, or the positions and/or orientations of groups of body parts.
ii) One or more costs e.g. negative rewards, may be similarly defined. A negative reward or cost may also or instead be associated with force applied by an actuator or end-effector, e.g. dependent upon a threshold or maximum applied force when interacting with an object. A negative reward may also be dependent upon energy or power usage, excessive motion speed, one or more positions of one or more robot body parts e.g. for constraining movement.

Objectives based on these rewards may be associated with different preferences e.g. a high preference for safety-related objectives such as a work envelope or the force applied to an object.

A robot may be or be part of an autonomous or semi-autonomous moving vehicle. Similar objectives may then apply. Also or instead such a vehicle may have one or more objectives relating to physical movement of the vehicle such as objectives (rewards) dependent upon: energy/power use whilst moving e.g. maximum or average energy use; speed of movement; a route taken when moving e.g. to penalize a longer route over a shorter route between two points, as measured by distance or time. Such a vehicle or robot may be used to perform a task such as warehouse, logistics, or factory automation, e.g. collecting, placing, or moving stored goods or goods or parts of goods during their manufacture; or the task performed may comprise a package delivery control task. Thus one or more of the objectives may relate to such tasks, the actions may include actions relating to steering or other direction control actions, and the observations may include observations of the positions or motions of other vehicles or robots.

In some other applications the same observations, actions, and objectives may be applied to a simulation of a physical system/environment as described above. For example a robot or vehicle may be trained in simulation before being used in a real-world environment.

In some applications the agent may be a static or mobile software agent i.e. a computer program configured to operate autonomously and/or with other software agents or people to perform a task. For example the environment may be an integrated circuit routing environment and the agent may be configured to perform a routing task for routing interconnection lines of an integrated circuit such as an ASIC. The objectives (rewards/costs) may then be dependent on one or more routing metrics such as an interconnect resistance, capacitance, impedance, loss, speed or propagation delay, physical line parameters such as width, thickness or geometry, and design rules. The objectives may include one or more objectives relating to a global property of the routed circuitry e.g. component density, operating speed, power consumption, material usage, or a cooling requirement. The observations may be observations of component positions and interconnections; the actions may comprise component placing actions e.g. to define a component position or orientation and/or interconnect routing actions e.g. interconnect selection and/or placement actions.

In some applications the agent may be an electronic agent and the observations may include data from one or more sensors monitoring part of a plant or service facility such as current, voltage, power, temperature and other sensors and/or electronic signals representing the functioning of electronic and/or mechanical items of equipment. The agent may control actions in a real-world environment including items of equipment, for example in a facility such as: a data center, server farm, or grid mains power or water distribution system, or in a manufacturing plant or service facility. The observations may then relate to operation of the plant or facility, e.g. they may include observations of power or water usage by equipment, or observations of power generation or distribution control, or observations of usage of a resource or of waste production. The actions may include actions controlling or imposing operating conditions on items of equipment of the plant/facility, and/or actions that result in changes to settings in the operation of the plant/facility e.g. to adjust or turn on/off components of the plant/facility. The objectives (to be maximized or minimized) may include one or more of: a measure of efficiency, e.g. resource usage; a measure of the environmental impact of operations in the environment, e.g. waste output; electrical or other power consumption; heating/cooling requirements; resource use in the facility e.g. water use; a temperature of the facility; a count of characteristics of items within the facility.

In some applications the environment may be a data packet communications network environment, and the agent may comprise a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The objectives may include objectives to maximize or minimize one or more of the routing metrics.

In some other applications the agent is a software agent which manages distribution of tasks across computing resources e.g. on a mobile device and/or in a data center. In these implementations, the observations may include observations of computing resources such as compute and/or memory capacity, or Internet-accessible resources; and the actions may include assigning tasks to particular computing resources. The objectives may include objectives dependent upon (e.g. to maximize or minimize) one or more of: utilization of computing resources, electrical power, bandwidth, and computation speed.

In some other applications the environment is an Internet or mobile communications environment and the agent is a software agent which manages a personalized recommendation for a user. The observations may comprise (features characterizing) previous actions taken by the user; the actions may include actions recommending items such as content items to a user. The objectives may include objectives to maximize or minimize one or more of: an estimated likelihood that the user will respond favorably to being recommended the (content) item, a constraint on the suitability of one or more recommended items, a cost of the recommended item(s), and a number of recommendations received by the user (optionally within a time span).

Corresponding features to those previously described may also be employed in the context of the above system and computer storage media.

The subject matter described in this specification can be implemented in particular embodiments so as to realize one or more of the following advantages. The subject matter described in this specification introduces a reinforcement learning method for learning a policy where there are multiple, potentially conflicting, objectives. This is achieved by determining objective-specific action-value functions. By utilizing these objective-specific functions, the methodology described herein provides objective-specific functions that are scale invariant; that is, the scale of the reward for a given objective does not affect the relative weighting between objectives.

The scale invariance of the proposed methodology has two key advantages. Firstly, the weighting between objectives does not need to be adjusted over time as the size of the rewards vary. This particularly advantageous in reinforcement learning, where an agent is likely to become better at performing a task as it is trained, thereby resulting in larger rewards over time. Secondly, objectives with relatively larger rewards do not necessarily dominate the training. Furthermore, by making the weighting the objectives scale invariant with regard to rewards, the methodology is easier to put into practice, avoiding the need for continual trial and error when selecting the weighting for varying reward sizes. Specific implementations are presented herein that provide improvements in computational efficiency (e.g. through the use of non-parametric objective-specific policies).

Some implementations of the described techniques are able to learn to perform a task taking into account multiple different, potentially conflicting objectives. Unlike some prior art techniques the technology described herein can adapt to rewards or penalties of different scales, which may change over time. In principle the described techniques can be applied to any reinforcement learning system which uses action-value functions (e.g. Q-value functions), although it is particularly useful for MPO (maximum a posterior policy optimization). The described techniques allow a reinforcement learning system with multiple different objectives to learn faster and in a more stable manner, thus reducing memory and computing requirements compared with prior systems. The described techniques work with both discrete actions and on real-world, high-dimensional, continuous control tasks.

In implementations a preference variable (ϵₖ) is assigned to each objective to control a degree to which the objective contributes to the update of the combined action selection policy of a reinforcement learning system. This is used to adjust a “temperature” associated with the objective, used to scale the action (Q) value associated with the objective. In implementations the “temperature” relates to a diversity of the actions contributing to an evaluation of the overall action selection policy. Thus the weighting between objectives may be scale invariant even if the scale of the rewards changes or the Q function is non-stationary. This allows a user to a priori set preferences between the various objectives.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system for reinforcement learning.

FIG. 2 shows a method for training via multi-objective reinforcement learning according to an arrangement.

FIG. 3 shows a method for training via multi-objective reinforcement learning including a two-step policy update procedure according to an arrangement.

Like reference numbers and designations in the various drawings indicate like elements.

### DETAILED DESCRIPTION

This specification describes techniques for learning where one or more agents are aiming to perform a task with multiple-competing objectives. This is common in the real world, where agents often have to balance competing objectives. For example, autonomous vehicles such as robots, may be required to complete a task (objective 1) whilst minimizing energy expenditure or damage to the environment (objective 2). Other examples of such agents include factory or plant automation systems, and computer systems. In such cases the agents may be the robots, items of equipment in the factory or plant, or software agents in a computer system which e.g. control the allocation of tasks to items of hardware or the routing of data on a communications network.

This specification generally describes a reinforcement learning system implemented as computer programs on one or more computers in one or more locations that selects actions to be performed by a reinforcement learning agent interacting with an environment by using a neural network. This specification also describes how such a system can adjust the parameters of the neural network.

In order to interact with the environment, the system receives data characterizing the current state of the environment and determines an action from an action space, i.e., a discrete action space or continuous action space, for the agent to perform in response to the received data. Data characterizing a state of the environment will be referred to in this specification as an observation. The agent performs the selected action which results in a change in the state of the environment.

In some implementations the environment is a simulated environment and the agent is implemented as one or more computers interacting with the simulated environment. For example a robot or vehicle may be trained in simulation before being used in a real-world environment.

In other implementations the environment is a real-world environment and the agent is a mechanical agent interacting with the real-world environment. For example, the agent may be a robot interacting with the environment to accomplish a specific task or an autonomous or semi-autonomous vehicle navigating through the environment. In these cases the observation can be data captured by one or more sensors of the agent as it interacts with the environment, e.g., a camera, a LIDAR sensor, a temperature sensor, and so forth.

Specific arrangements described herein provide methods for training a reinforcement learning system that has multiple, potentially conflicting objectives (multi-objective reinforcement learning).

Traditional reinforcement learning (RL) methods do an excellent job at training policies to optimize a single scalar reward function. However, many real-world tasks involve multiple, possibly competing, objectives. For instance, controlling energy systems may require trading off performance and cost; controlling autonomous cars may trade off fuel costs, efficiency, and safety; and controlling robotic arms may require trading off speed, energy efficiency and safety. Multi-objective reinforcement learning (MORL) methods aim to tackle such problems. One approach is scalarization: based on preferences across objectives, transform the multi-objective reward vector into a single scalar reward (e.g., by taking a convex combination), and then use standard RL to optimize this scalar reward.

It is difficult, though, for practitioners to pick the appropriate scalarization for a desired preference across objectives, because often objectives are defined in different units and/or scales. For instance, suppose we want an agent to complete a task while minimizing energy usage and mechanical wear-and-tear. Task completion may correspond to a sparse reward or to the number of square feet a vacuuming robot has cleaned, and reducing energy usage and mechanical wear-and-tear could be enforced by penalties on power consumption (in kWh) and actuator efforts (in N or Nm), respectively. Practitioners would need to resort to using trial and error to select a scalarization that ensures the agent prioritizes actually doing the task (and thus being useful) over saving energy.

To overcome this problem, the present application proposes a scale-invariant approach for encoding preferences, derived from the RL-as-inference perspective. Arrangements described herein learn an action-value function and an action distribution per objective that improves on the current policy. Then, to obtain a single updated policy that makes these trade-offs, supervised learning can be used to fit a policy to the combination of these action distributions.

In order to weight the relative objectives, instead of choosing a scalarization, practitioners set a constraint per objective. These constraints can control the influence of each objective on the policy, e.g. by constraining the KL-divergence between each objective-specific distribution and the current policy. The higher the constraint value, the more influence the objective has. Thus, a desired preference over objectives can be encoded as the relative magnitude of these constraint values.

Fundamentally, scalarization combines objectives in reward space. In contrast, the approach proposed herein combines objectives in distribution space thus making it invariant to the scale of rewards. In principle, this approach can be combined with any RL method, regardless of whether it is off-policy or on-policy. Specific arrangements described herein combine it with maximum a posteriori policy optimization (MPO), an off-policy actor-critic RL method, and V-MPO, an on-policy variant of MPO. These two methods are referred to herein as multi-objective MPO (MO-MPO) and multi-objective VMPO (MO-V-MPO), respectively.

Ultimately, the present methodology provides a distributional view on multi-objective reinforcement learning (MORL), which enables scale-invariant encoding of preferences. This is a theoretically-grounded approach, that arises from taking an RL-as-inference perspective of MORL. Empirically, the mechanics of MO-MPO have been analysed and shown that it finds all Pareto-optimal policies in a popular MORL benchmark task. MO-MPO and MO-V-MPO outperform scalarized approaches on multi-objective tasks across several challenging high-dimensional continuous control domains.

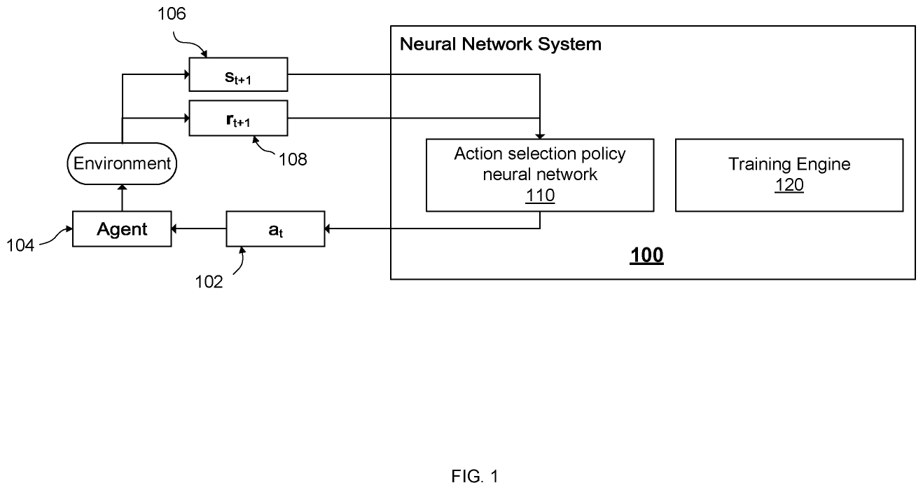

FIG. 1 shows an example neural network system 100 for reinforcement learning. The neural network system 100 is an example of a system implemented as computer programs on one or more computers in one or more locations in which the systems, components, and techniques described below are implemented.

The neural network system 100 includes an action selection policy neural network 110 that determines actions 102 that are output to an agent 104 for application to an environment. The neural network system 100 operates over a number of time steps t. Each action aₜ 102 is determined based on an observation characterizing a current state sₜ 106 of the environment. Following the input of an initial observation characterizing an initial state s₀ 106 of the environment, the neural network system 100 determines an action a₀ 102 and outputs this action 102 to the agent 104. After the agent 104 has applied the action 102 to the environment 104, an observation of an updated state s₁ 106 is input into the neural network 100. The neural network 100 therefore operates over multiple time steps t to select actions aₜ 102 in response to input observations sₜ 106. Each action aₜ 102 is determined based on a policy π_{θ} which is dependent on a set of policy parameters θ. In one arrangement, the action selection policy neural network 110 is a feedforward neural network, although other types of neural network may be utilized. For each time step, a set of rewards rₜ 108 for the previous action aₜ₋₁ is also received. The set of rewards rₜ 108 includes a reward for each objective.

The observations may include an image of the environment and/or other sensor or input data from the environment. Such observations are typically pre-processed e.g. by one or more convolutional neural network layers, and/or one or more recurrent neural network layers.

The system 100 also includes a training engine 120 configured to update parameters of the policy based on the rewards 108 received for each objective. When training the neural network system 100, the system can operate over one or more time steps t, selecting one or more corresponding actions aₜ 102 based on the current state sₜ 108 and the current policy π_{θ}, before the policy parameters θ are updated based on the rewards rₜ 108 for each action aₜ 102. Batch training can be utilized, where a given policy is applied to multiple time steps before it is updated.

Formally, the present arrangement applies a multi-objective RL problem defined by a multi-objective Markov Decision Process (MO-MDP). The MO-MDP consists of states s∈ [symbol] and actions a∈ [symbol] , an initial state distribution p(s₀) and transition probabilities p(sₜ₊₁|sₜ; aₜ) which define the probability of changing from state sₜ to sₜ₊₁ when taking action aₜ. In the present arrangement, the neural network system 100 applies multiple objectives. Accordingly, a reward function {rₖ(s,a)∈ [symbol] }ₖ₌₁^{N} is assigned for each objective k. A discount factor γ∈[0,1) is provided for application to the rewards. A policy π_{θ}(a|s) is defined as a state conditional distribution over actions parametrized by θ. Together with the transition probabilities, this gives rise to a state visitation distribution μ(s).

In addition to objective-specific rewards, an action-value function (Q-function) is provided for each objective. The action-value function maps states and actions to a value. The action-value function for objective k is defined as the expected return (i.e., the cumulative discounted reward) from choosing action a in state s for objective k and then following policy π: Qₖ^{π}(s, a)= [symbol] _{π}[Σₜ₌₀^{∞}γ^{t}rₖ(sₜ, aₜ)|s₀=s, a₀=a]. This function can be represented using the recursive expression Qₖ^{π}(sₜ, aₜ)= [symbol] ₚ(sₜ₊₁|sₜ,aₜ)[rₖ(sₜ,aₜ)+γVₖ^{π}(sₜ₊₁)], where Vₖ^{π}(s)= [symbol] _{π}[Qₖ^{π}(s, a)] is the value function of π for objective k.

During training, the system 100 attempts to identify an optimal policy. For any MO-MDP there is a set of nondominated policies, i.e., the Pareto front. A policy is nondominated if there is no other policy that improves its expected return for an objective without reducing the expected return of at least one other objective. Given a preference setting, the goal of the present methodology is to find a nondominated policy π_{θ} that satisfies those preferences. In the present approach, a setting of constraints does not directly correspond to a particular scalarization, but by varying these constraint settings, a Pareto front of policies can be traced out.

In general, the training involves a two-step approach to update the policy. Firstly, action distributions (objective-specific policies) are determined for each objective based on the corresponding action-value function. Then, the overall policy is fitted to a combination of the action distributions.

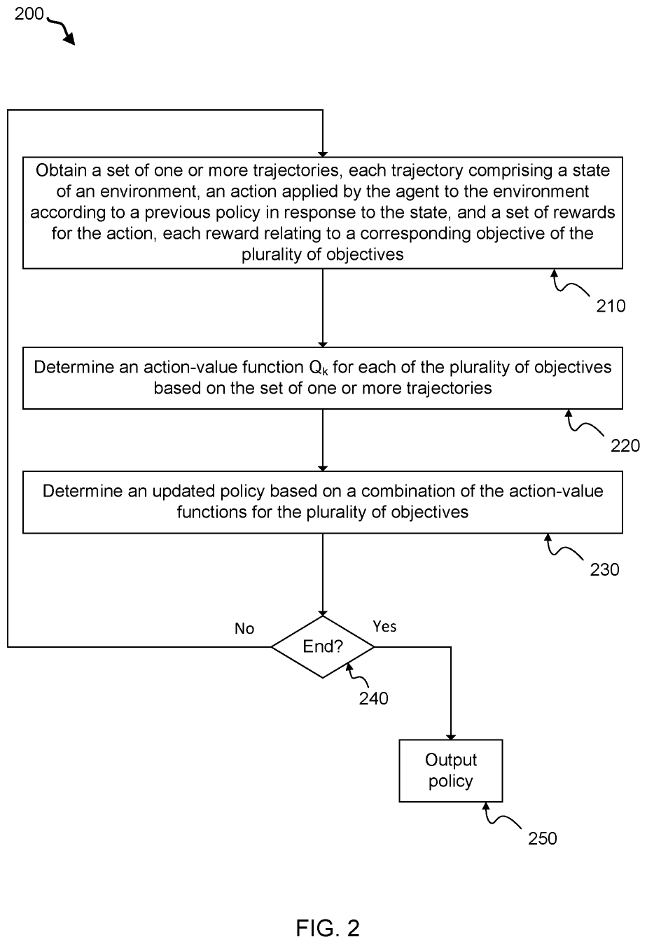

FIG. 2 shows a method for training via multi-objective reinforcement learning according to an arrangement. The method splits the reinforcement learning problem into two sub-problems and iterates until convergence:

1. Policy evaluation: estimate Q-functions given policy π_{θ}

2. Policy improvement: update policy given Q-functions

Algorithm 1 summarizes this two-step multi-objective policy improvement procedure.

At each iteration of the training method, a set of trajectories are obtained 210, before an action-value function for each objective is determined 220. An updated policy is then determined based on a combination of the action-value functions 230. The method determines if an end criterion is reached 240 (e.g. a fixed number of iterations have been performed, or the policy meets a given level of performance). If not, then another iteration is performed based on the updated policy π_{θ}. If so, then the policy is output 250 (e.g. stored locally or transmitted to an external device, e.g. an agent for implementing the policy).

Each trajectory comprises a state sₜ, an action aₜ determined based on the policy π_{θ} and applied to the environment, and a set of rewards rₜ for that action aₜ, over one or more timesteps t (up to a total of N timesteps). Each reward in the set of rewards rₜ for each action relates to a corresponding objective. Each reward can either be received from an external source (e.g. the environment) or can be determined based on the state sₜ of the environment (e.g. based on a corresponding reward function). In addition, multiple trajectories may be obtained over a number of episodes from a number of different starting states s₀ according to a batch size (L) defining the total number of episodes.

When determining an action-value function for each objective 220, this may be an update to a previous action-value function for the objective. This determination/update is based on the trajectories that have been obtained (i.e. based on the actions, states and rewards from the one or more trajectories). The specifics of this determination shall be discussed in more detail below.

Algorithm 1 MO-MPO: One policy improvement step

| | |
|---|---|
| 1: | given batch size (L), number of actions to sample (M), (N) |
| | Q-functions {Qₖ^{π}^{_{old}} (s, a)}ₖ₌₁^{N}, preferences {ϵₖ}ₖ₌₁^{N}, previous |
| | policy π_{old}, previous temperatures {ηₖ}ₖ₌₁^{N}, replay buffer [symbol] , |
| | first-order gradient-based optimizer [symbol] |
| 2: | |
| 3: | initialize π_{θ} from the parameters of π_{old} |
| 4: | repeat |
| 5: | // Collect dataset {sⁱ, a^{ij}, Qₖ^{ij}}_{i,j,k}^{L,M,N}, where |
| 6: | // M actions a^{ij} ~ π_{old} (a\|sⁱ) and Qₖ^{ij} = Qₖ^{π}^{_{old}} (sⁱ,a^{ij}) |
| 7: | |
| 8: | // Compute action distribution for each objective |
| 9: | for k = 1, . . . , N do |
| 10: | ${δ}_{{η}_{k}} ← {∇}_{{η}_{k}} {η}_{k} {ϵ}_{k} + {η}_{k} {\sum }_{i}^{L} \frac{1}{L} log ( {\sum }_{j}^{M} \frac{1}{M} exp ( \frac{{Q}_{k}^{ij}}{{η}_{k}} ) )$ |
| 11: | Update nk based on δ_{η}_{ₖ} , using optimizer [symbol] |
| 12: | ${q}_{k}^{ij} ∝ exp ( \frac{{Q}_{k}^{ij}}{{η}_{k}} )$ |
| 13: | end for |
| 14: | |
| 15: | // Update parametric policy |
| 16: | δ_{π} [symbol] −∇_{θ} Σᵢ^{L} Σⱼ^{M} Σₖ^{N} qₖ^{ij} log π_{θ} (a^{ij}\|sⁱ) |
| 17: | (subject to additional KL regularization) |
| 18: | Update π_{θ} based on δ_{π}, using optimizer [symbol] |
| 19: | |
| 20: | until fixed number of steps |
| 21: | return π_{old} = π_{θ} |

### Multi-Objective Policy Evaluation

The neural network system evaluates the previous policy—old by learning state-action value (Q) functions. A separate Q-function is trained per objective, following a Q-decomposition approach. In principle, any Q-learning algorithm can be used, as long as the target Q-value is computed with respect to π_{old} (the policy prior to the current iteration of the update).

In general, Q-learning aims to learn an approximation of the action-value function. To achieve this, the following update may be applied at each iteration of training to learn a Q-function Qₖ^{π}^{_{old}}(s, a) for each objective k, parameterized by ϕₖ:

Qₖ^{π}^{_{old}}(S,A;ϕₖ)←Qₖ^{π}^{_{old}}(S,A;ϕₖ)+α[\hat{Q}ₖ(S,A,R)−Qₖ^{π}^{_{old}}(S,A;ϕₖ)]

where \hat{Q}ₖ (S, A, R) is a target action-value function (a target Q-function) based on state S, action A and reward R vectors. The target Q-value is an estimate of the sum of discounted rewards (e.g. as determined from one or more trajectories obtained by running the policy).

Different types of target Q-functions exist, and are equally applicable to the present methodology. In a specific implementation, a Retrace objective is used to learn the Q-function Qₖ^{π}^{_{old}}(s, a) for each objective k, parameterized by ϕₖ, as follows:

$${min}_{{\{ {ϕ}_{k} \}}_{1}^{N}} {\sum }_{k = 1}^{N} {𝔼}_{( {s}_{t} , {a}_{t} ) \sim 𝒟} [ {( {\hat{Q}}_{k}^{ret} ( {s}_{t} , {a}_{t} ) - {Q}_{k}^{{π}_{old}} ( {s}_{t} , {a}_{t} ; {ϕ}_{k} ) )}^{2} ]$$

where \hat{Q}ₖ^{ret} is the Retrace target for objective k and the previous policy π_{old}, and [symbol] is a replay buffer containing gathered transitions (state-action pairs). This minimizes the mean squared error between the Retrace target and the Q-function being learned.

In this implementation, the Retrace target is as follows:

$${\hat{Q}}_{k}^{ret} ( {s}_{t} , {a}_{t} ) = {\hat{Q}}_{k}^{{π}_{old}} ( {s}_{t} , {a}_{t} ; {ϕ}_{k} ) + {\sum }_{j = t}^{T} {γ}^{j - t} ( {\prod }_{z = t + 1}^{j} {c}_{z} ) {δ}^{j} where \\ {δ}^{j} = {r}_{k} ( {s}_{j} , {a}_{j} ) + γ V ( {s}_{j + 1} ) - {\hat{Q}}_{k}^{{π}_{old}} ( {s}_{j} , {a}_{j} ; {ϕ}_{k} ) \\ V ( {s}_{j + 1} ) = {𝔼}_{{π}_{old} ( a \vert {s}_{j + 1} )} [ {\hat{Q}}_{k}^{{π}_{old}} ( {S}_{j + 1} , a ; {ϕ}_{k} ) ]$$

The importance weights c_{z} are defined as

$${c}_{z} = min ( 1 , \frac{{π}_{old} ( {a}_{z} \vert {s}_{z} )}{b ( {a}_{z} \vert {s}_{z} )} )$$

where b(a_{z}|s_{z}) denotes a behaviour policy used to collect trajectories in the environment. When j=t, the method sets (Π_{z=t+1}^{j}c_{z})=1.

In a specific implementation, two networks for the Q-functions are maintained for each objective, one online network and one target network, with parameters denoted by ϕₖ and ϕ′ₖ, respectively. Similarly one online network and one target network may be maintained for the policy, with parameters denoted by θ and θ′, respectively. Target networks may be updated every fixed number of steps by copying parameters from the online network. Online networks may be updated using any appropriate update method, such as gradient descent, in each learning iteration. The target policy network is referred to above as the old policy, π_{old}.

In a specific implementation, an asynchronous actor-learner setup may be used, in which actors regularly fetch policy parameters from the learner and act in the environment, writing these transitions to the replay buffer. This policy is referred to as the behavior policy. The learner uses the transitions in the replay buffer to update the (online) Q-functions and the policy. This methodology is shown in more detail in Algorithm 2.

Algorithm 2 is a method of obtaining trajectories based on a given policy π_{θ}. The system fetches the current policy parameters θ defining the current policy π_{θ}. The system then collects a set of trajectories over a number of time steps T. Each trajectory τ includes a state sₜ, an action aₜ and a set of rewards r for each of the timesteps. The set of rewards r includes a reward rₖ for each objective. The system obtains the trajectory τ by determining, for each time step, an action aₜ based on the current state sₜ and based on the current policy π_{θ} and determining rewards from the next state sₜ₊₁ that results from the action being performed based on a set of reward functions {rₖ(s,a)}ₖ₌₁^{N}. A trajectory τ is obtained for each of a number L of episodes. Each trajectory τ is stored in the replay buffer [symbol] . The stored trajectories are then used to update the Q-function for each objective.

Algorithm 2 MO-MPO: Asynchronous Actor

| | |
|---|---|
| 1: | given (N) reward functions {rₖ(s, a)}ₖ₌₁^{N}, |
| | T steps per episode |
| 2: | repeat |
| 3: | Fetch current policy parameters θ from learner |
| 4: | // Collect trajectory from environment |
| 5: | τ = { } |
| 6: | for t = 0,..., T do |
| 7: | aₜ ~ π_{θ}(·\|sₜ) |
| 8: | // Execute action and determine rewards |
| 9 | r = [r₁(sₜ, aₜ),..., r_{N}(sₜ,aₜ)] |
| 10 | τ [symbol] τ [symbol] {(sₜ,aₜ,r,π_{θ}(aₜ\|sₜ))} |
| 11: | end for |
| 12: | Send trajectory τ to replay buffer |
| 13: | until end of training |

### Multi-Objective Policy Improvement

Given the previous policy π_{old}(a|s) and associated Q-functions {Qₖ^{π}^{_{old}}(s,a)}ₖ₌₁^{N} the next step is to improve the previous policy for a given visitation distribution μ(s). This may be achieved by drawing from the replay buffer to estimate expectations over the visitation distribution. To this end, the system learns an action distribution (an objective-specific policy) for each Q-function and combines these to obtain the next policy π_{new}(a|s).

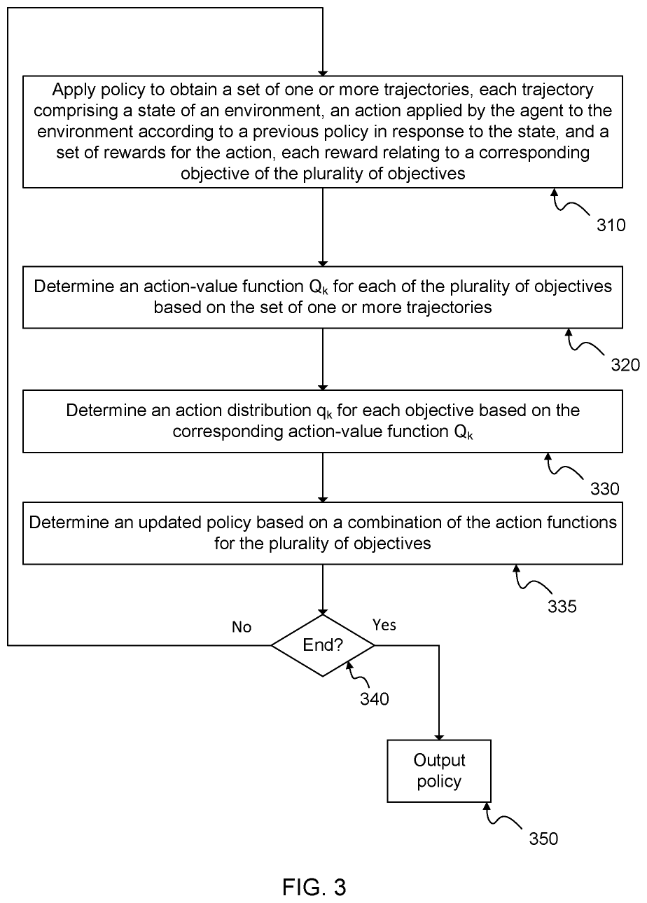

FIG. 3 shows a method for training via multi-objective reinforcement learning including a two-step policy update procedure according to an arrangement. The method broadly matches the method of FIG. 2, however the policy update step has been replaced with two steps:
1. Determining an action distribution for each objective based on the corresponding action-value function 330.
2. Determining an updated policy based on a combination of the action functions for the plurality of objectives 335.

In the first step 330, for each objective k an improved action distribution qₖ(a|s) is learned such that [symbol] _{qk(a|s)}[Qₖ^{π}^{_{old}}(s,a)]≥ [symbol] _{π}_{_{old}}_{(a|s)}[Qₖ^{π}^{_{old}}(s,a)], where states s are drawn from a visitation distribution μ(s) (e.g. taken from the replay buffer). In other words, an improved action distribution qₖ(a|s) is learned such that the expectation of the Q-function with respect to the action distribution is greater than or equal to the expectation of the Q-function with respect to the policy.

In the second step 335, the improved distributions qₖ are combined and distilled into a new parametric policy π_{new} (with parameters θ_{new}) by minimizing the difference between the distributions and the new parametric policy. This can be achieved by minimizing the KL-divergence between the distributions and the new parametric policy, i.e.,

$${θ}_{n e w} = {arg min}_{θ} {\sum }_{k = 1}^{N} {𝔼}_{μ ( s )} [ K L ( {q}_{k} ( a \vert s ) ‖ {π}_{θ} ( a \vert s ) ) ]$$

where KL(qₖ(a|s)∥π_{θ}(a|s)) is the Kullback-Leibler divergence between an action distribution qₖ(a|s) for objective k and the policy π_{θ}(a|s). This is a supervised learning loss that determines a maximum likelihood estimate of each distribution qₖ. Next, these two steps will be explained in more detail.

### Obtaining Action Distributions Per Objective (Step 1)

To obtain the per-objective improved action distributions qₖ(a|s), the reinforcement learning objective is optimized for each objective Qₖ:

$${max}_{{q}_{k}} {\int }_{s} μ ( s ) {\int }_{a} {q}_{k} ( a \vert s ) {Q}_{k} ( s , a ) da ds s . t . {\int }_{s} μ ( s ) K L ( {q}_{k} ( a \vert s ) ‖ {π}_{o l d} ( a \vert s ) ) ds < {ϵ}_{k}$$

where ϵₖ denotes the allowed expected KL divergence for objective k. These ϵₖ are used to encode preferences over the objectives. More concretely, ϵₖ defines the allowed influence of objective k on the change on policy.

For nonparametric action distributions qₖ(a|s) this constrained optimization problem can be solved in closed form for each state s sampled from μ(s),

$${q}_{k} ( a \vert s ) ∝ {π}_{old} ( a \vert s ) exp ( \frac{{Q}_{k} ( s , a )}{{η}_{k}} )$$

where the temperature ηₖ is computed based on the corresponding ϵₖ by solving the following convex dual function:

$${η}_{k} = {arg min}_{η} η {ϵ}_{k} + η {\int }_{s} μ ( s ) log {\int }_{a} {π}_{old} ( a \vert s ) exp ( \frac{{Q}_{k} ( s , a )}{{η}_{k}} ) da ds$$

In order to evaluate qₖ(a|s) and the integrals above, the system can draw L states from the replay buffer and, for each state, samples M actions from the current policy π_{old}. In practice, one temperature parameter πₖ is maintained per objective. We have found that optimizing the dual function by performing a few steps of gradient descent on ηₖ is effective. The method is initialized with the solution found in the previous policy iteration step. Since ηₖ should be positive, a projection operator can be used after each gradient step to maintain ηₖ>0.

As shown in Algorithm 1, the action distribution qₖ(a Is) for each objective can be calculated by calculating:

$${δ}_{{η}_{k}} ← {∇}_{{η}_{k}} {η}_{k} {ϵ}_{k} + {η}_{k} {\sum }_{i}^{L} \frac{1}{L} log ( {\sum }_{j}^{M} \frac{1}{M} exp ( \frac{{Q}_{k}^{i , j}}{{η}_{k}} ) ) ,$$

updating ηₖ based on δ_{η}_{ₖ} using an optimizer, and then determining the action distribution qₖ(a|s)

$${q}_{k} ( a \vert s ) ∝ {π}_{old} ( a \vert s ) exp ( \frac{{Q}_{k} ( s , a )}{{η}_{k}} ) .$$

Since the constraints ϵₖ encode the preferences over objectives, solving this optimization problem with good satisfaction of constraints is important for learning a policy that satisfies the desired preferences. For nonparametric action distributions qₖ(a|s), these constraints can be satisfied exactly. One could use any policy gradient method to obtain qₖ(a|s) in a parametric form instead. However, solving the constrained optimization for parametric qₖ(a|s) is not exact, and the constraints may not be well satisfied, which impedes the use of ϵₖ to encode preferences. Moreover, assuming a parametric qₖ(a|s) requires maintaining a function approximator (e.g., a neural network) per objective, which can significantly increase the complexity of the algorithm and limits scalability.

### Fitting a New Parametric Policy (Step 2)

In the previous section, for each objective k, an improved action distribution qₖ(a|s) (an improved objective-specific policy) has been obtained. Next, these distributions need to be combined to obtain a single parametric policy that trades off the objectives according to the constraints ϵₖ that have been set. For this, the method solves a supervised learning problem that fits a parametric policy to the per-objective action distributions from step 1,

$${θ}_{n e w} = {arg max}_{θ} {\sum }_{k = 1}^{N} {\int }_{s} μ ( s ) {\int }_{a} {q}_{k} ( a \vert s ) log {π}_{θ} ( a \vert s ) da ds s . t . {\int }_{s} μ ( s ) KL ( {π}_{old} ( a \vert s ) ‖ {π}_{θ} ( a \vert s ) ) ds < β ,$$

where θ are parameters of the policy neural network and the KL constraint enforces a trust region of size β that limits the overall change in the parametric policy. The KL constraint in this step has a regularization effect that prevents the policy from overfitting to the sample-based action distributions, and therefore avoids premature convergence and improves stability of learning.

Similar to the first policy improvement step, the integrals can be evaluated by using the L states sampled from the replay buffer and the M actions per state sampled from the old policy. In order to optimize the above using gradient descent, Lagrangian relaxation can be implemented.

As shown in Algorithm 1, the policy π_{θ}(a|s) can be updated by calculating:

$${δ}_{π} ← - {∇}_{θ} {\sum }_{i}^{L} {\sum }_{j}^{M} {\sum }_{k}^{N} {q}_{k}^{i , j} log {π}_{θ} ( {a}^{i , j} \vert {s}^{i} )$$

subject to the above regularization constraint. The policy parameters can then be updated based on δ_{π} using an optimizer (e.g. via gradient descent).

### On-Policy Learning

The above implementations discuss batch learning. The methodology described herein can be equally applied to on-policy learning. In this case, to evaluate the previous policy π_{old} advantages A (s, a) are estimated from a learned state-value function V(s), instead of a state-action value function Q(s, a) as in the off-policy implementations. A separate V-function for each objective is trained by regressing to an n-step return associated with each objective.

More concretely, given trajectory snippets τ={(s₀,a₀,r₀), . . . , (s_{T},a_{T},r_{T})} where rₜ denotes a reward vector {rₖ(sₜ,aₜ)}ₖ₌₁^{N} that consists of rewards for all N objectives, value function parameters ϕₖ are found by optimizing the following objective:

$${min}_{{\{ {ϕ}_{k} \}}_{1}^{N}} {\sum }_{k = 1}^{N} {𝔼}_{τ} [ {( {G}^{( T )} ( {s}_{t} , {a}_{t} ) - {V}_{{ϕ}_{k}}^{{π}_{old}} ( {s}_{t} ) )}^{2} ] .$$

Here G^{(T)}(sₜ,aₜ) is the T-step target for value function k, which uses the actual rewards in the trajectory and bootstraps from the current value function for the rest: Gₖ^{(T)}(sₜ,aₜ)=Σₗ₌ₜ^{T-1}γ^{l-t}rₖ(sₗ,aₗ)+γ^{T-t}V_{ϕ}_{ₖ}^{π}^{_{old}}(s_{l+T}). The advantages are then estimated as Aₖ^{π}^{_{old}}(sₜ,aₜ)=Gₖ^{(T)}(sₜ, aₜ)−V_{ϕ}_{ₖ}^{π}^{_{old}}(sₜ).

Given the previous policy π_{old}(a|s) and estimated advantages {Aₖ^{π}^{_{old}}(s,a)}_{k=1, . . . , N} associated with this policy for each objective, the goal is to improve the previous policy. To this end, the method first learns an improved variational distribution qₖ(s, a) for each objective, and then combines and distils the variational distributions into a new parametric policy π_{new}(a|s). Unlike in the off-policy implementations, this implementation uses the joint distribution qₖ(s, a) rather than local policies qₖ(s|a) because, without a learned Q-function, only one action per state is available for learning. Each joint distribution provides a probability of state-action pairs given a corresponding objective.

In order to obtain the improved variational distributions qₖ(s, a), the method optimizes the RL objective for each objective

$${max}_{{q}_{k}} {\int }_{s , a} {q}_{k} ( s , a ) {A}_{k} ( s , a ) da ds s . t . KL ( {q}_{k} ( s , a ) ‖ {p}_{o l d} ( s , a ) ) < {ϵ}_{k} ,$$

where the KL-divergence is computed over all (s, a), ϵₖ denotes the allowed expected KL divergence, and p_{old}(s, a)=μ(s)π_{old}(a|s) is the state-action distribution associated with π_{old}.

As in the off-policy implementations, this on-policy implementation uses ϵₖ to define the preferences over objectives. More concretely, ϵₖ defines the allowed contribution of objective k to the change of the policy. Therefore, the larger a particular ϵₖ is with respect to others, the more that objective k is preferred. On the other hand, if ϵₖ=0, then objective k will have no contribution to the change of the policy and will effectively be ignored.

The above equation can be solved in closed form:

$${q}_{k} ( s , a ) ∝ {p}_{o l d} ( s , a ) exp ( \frac{{A}_{k} ( s , a )}{{η}_{k}} ) ,$$

where the temperature ηₖ is computed based on the constraint ϵₖ by solving the following convex dual problem

$${η}_{k} = {arg min}_{{η}_{k}} [ {η}_{k} {ϵ}_{k} + {η}_{k} log {\int }_{s , a} {p}_{o l d} ( s , a ) exp ( \frac{{A}_{k} ( s , a )}{{η}_{k}} ) da ds ] .$$

The optimization can be performed along with the loss by taking a gradient descent step on ηₖ, and this can be initialized with the solution found in the previous policy iteration step. Since ηₖ must be positive, a projection operator can be used after each gradient step to maintain ηₖ>0.

In practice, training can be performed using samples corresponding to a proportion of the largest advantages (e.g. the top 50%) in each batch of data.

The next step is to combine and distil the state-action distributions obtained in the previous step into a single parametric policy π_{new}(a|s) that favours all of the objectives according to the preferences specified by ϵₖ. For this a supervised learning problem can be solved that fits a parametric policy as follows:

$${π}_{n e w} = {arg max}_{θ} {\sum }_{k = 1}^{N} {\int }_{s , a} {q}_{k} ( s , a ) log {π}_{θ} ( a \vert s ) da ds s . t . {\int }_{s , a} KL ( {π}_{old} ( a \vert s ) ‖ {π}_{θ} ( a \vert s ) ) ds < β ,$$

where θ are the parameters of the function approximator (a neural network), which are initialized from the weights of the previous policy π_{old}, and the KL constraint enforces a trust region of size β that limits the overall change in the parametric policy, to improve stability of learning. As in the off-policy implementations, the KL constraint in this step has a regularization effect that prevents the policy from overfitting to the local policies and therefore avoids premature convergence.

In order to optimize the above equation, Lagrangian relaxation may be employed.

### Selecting ϵₖ

It is more intuitive to encode preferences via ϵₖ rather than via scalarization weights, because the former is invariant to the scale of rewards. In other words, having a desired preference across objectives narrows down the range of reasonable choices for ϵₖ, but does not narrow down the range of reasonable choices for scalarization weights. In order to identify reasonable scalarization weights, a RL practitioner needs to additionally be familiar with the scale of rewards for each objective. In practice, we have found that learning performance is robust to a wide range of scales for ϵₖ. It is the relative scales of the ϵₖ that matter for encoding preferences over objectives—the larger a particular ϵₖ is with respect to others, the more that objective k is preferred. On the other hand, if ϵₖ=0, then objective k will have no influence and will effectively be ignored. In general, specific implementations apply ϵₖ in the range of 0.001 to 0.1.

When all objectives are equally important, the general rule is to set all ϵₖ to the same value. In contrast, it can be difficult to choose appropriate weights in linear scalarization to encode equal preferences—setting all weights equal to 1/K (where K is the number of objectives) is only appropriate if the objectives' rewards are of similar scales.

Even when setting all ϵₖ to the same value, the absolute value of ϵₖ will have an effect on the learning. The larger ϵₖ is, the more influence the objectives will have on the policy update step. Since the per-objective critics are learned in parallel with the policy, setting ϵₖ too high tends to destabilize learning, because early on in training, when the critics produce unreliable Q-values, their influence on the policy will lead it in the wrong direction. On the other hand, if ϵₖ is set too low, then it slows down learning, because the per-objective action distribution is only allowed to deviate by a tiny amount from the current policy, and the updated policy is obtained via supervised learning on the combination of these action distributions. Nevertheless, the learning eventually will converge to more or less the same policy, as long as ϵₖ is not set too high.

When there is a difference in preferences across objectives, the relative scale of ϵₖ is what matters. The more the relative scale of ϵₖ is compared to ϵₗ, the more influence objective k has over the policy update, compared to objective l. In the extreme case, when ϵₗ is near-zero for objective l, then objective l will have no influence on the policy update and will effectively be ignored.

One common example of unequal preferences is when an agent is required to complete a task, while minimizing other objectives—e.g., energy expenditure, force applied (e.g. a “pain” penalty), etc. In this case, the E for the task objective should be higher than that for the other objectives, to incentivize the agent to prioritize actually doing the task. If the E for the penalties is too high, then the agent will care more about minimizing the penalty (which can typically be achieved by simply taking no actions) rather than doing the task, which is not particularly useful.

The scale of ϵₖ has a similar effect as in the equal preference case. If the scale of ϵₖ is too high or too low, then the same issues arise as discussed for equal preferences. If all ϵₖ increase or decrease in scale by the same (moderate) factor, and thus their relative scales remain the same, then typically they will converge to more or less the same policy. As mentioned, ϵₖ in the range of 0.001 to 0.1 can achieve good results.

The subject matter described in this specification introduces a reinforcement learning method for learning a policy where there are multiple, potentially conflicting, objectives. This is achieved by determining objective-specific action-value functions. By utilizing these objective-specific functions, the methodology described herein provides objective-specific functions that are independent of the scale of the reward for a given objective. This means that the weighting between objectives does not need to be adjusted over time as the size of the rewards vary. In addition, larger rewards do not necessarily dominate the training. Furthermore, by making the weighting the objectives scale invariant with regard to rewards, the methodology is easier to put into practice, avoiding the need for continual trial and error when selecting the weighting for varying reward sizes. Specific implementations are presented herein that provide improvements in computational efficiency (e.g. through the use of non-parametric objective-specific policies).

In certain implementations a preference variable (ϵₖ) is assigned to each objective to control a degree to which the objective contributes to the update of the combined action selection policy of a reinforcement learning system. This is used to adjust a “temperature” associated with the objective, used to scale the action (Q) value associated with the objective. In implementations, the “temperature” relates to a diversity of the actions contributing to an evaluation of the overall action selection policy. Thus, the weighting between objectives may be scale invariant even if the scale of the rewards changes or the Q function is non-stationary. This allows a user to a priori set preferences between the various objectives.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method for training a neural network system by reinforcement learning, the neural network system being configured to receive an input observation characterizing a state of an environment interacted with by an agent and to select and output an action in accordance with a policy that aims to satisfy a plurality of objectives, the method comprising:
obtaining a set of one or more trajectories, each trajectory comprising a state of an environment, an action applied by the agent to the environment according to a previous policy in response to the state, and a set of rewards for the action, each reward relating to a corresponding objective of the plurality of objectives;
determining an action-value function for each of the plurality of objectives based on the set of one or more trajectories, each action-value function determining an action value representing an estimated return according to the corresponding objective that would result from the agent performing a given action in response to a given state according to the previous policy; and
determining an updated policy based on a combination of the action-value functions for the plurality of objectives.

2. The method of claim 1 wherein determining an updated policy comprises:
determining an objective-specific policy for each objective in the plurality of objectives, each objective-specific policy being determined based on the corresponding action-value function for the corresponding objective; and
determining the updated policy by fitting a set of policy parameters of the updated policy to a combination of the objective-specific policies.

3. The method of claim 2 wherein fitting the set of policy parameters of the updated policy to the combination of the objective-specific policies comprises determining the set of policy parameters that minimizes a difference between the updated policy and the combination of the objective-specific policies.

4. The method of claim 2 wherein the set of policy parameters for the updated policy are constrained such that the difference between the updated policy and the previous policy cannot exceed a trust region threshold.

5. The method of claim 2 wherein determining an objective-specific policy for each objective comprises determining objective-specific policy parameters for the objective-specific policy that increase the expected return according to the action-value function for the corresponding objective relative to the previous policy.

6. The method of claim 5 wherein determining the objective-specific policy for each objective comprises determining objective-specific policy parameters for the objective-specific policy that maximize the expected return according to the action-value function for the corresponding objective relative to the previous policy, subject to a constraint that the objective-specific policy may not differ from the previous policy by more than a corresponding difference threshold.

7. The method of claim 6 wherein the corresponding difference threshold represents the relative contribution of the corresponding objective to the updated policy.

8. The method of claim 2 wherein the objective-specific policies are non-parametric policies.

9. The method of claim 2 wherein each objective-specific policy, qₖ(a|s), is determined from a scaled action-value function for the objective of the objective-specific policy, wherein the scaled action-value function is scaled by a value dependent upon a preference for the objective.

10. The method of claim 9 when dependent on claim 6 wherein the value dependent upon a preference for the objective is dependent on the difference threshold for the objective.

11. The method of claim 8 wherein each objective-specific policy, qₖ(a|s), is determined by calculating:
$${q}_{k} ( a \vert s ) = N {π}_{old} ( a \vert s ) exp ( \frac{{Q}_{k} ( s , a )}{{η}_{k}} )$$
where:
N is a normalization constant;
k is the objective;
a is an action;
s is a state;
π_{old}(a|s) is the previous policy;
Qₖ(s,a) is the action-value function for the objective; and
ηₖ is a temperature parameter.

12. The method of claim 11 wherein, for each objective, k, the temperature parameter ηₖ is determined by solving the following equation:
$${η}_{k} = {arg min}_{η} {ηϵ}_{k} + η {\int }_{s} μ ( s ) log {\int }_{a} {π}_{old} ( a \vert s ) exp ( \frac{{Q}_{k} ( s , a}{η} ) da ds$$
where:
ϵₖ is the difference threshold for the corresponding objective; and
μ(s) is a visitation distribution.

13. The method of claim 12 wherein each temperature parameter is determined via gradient descent.

14. The method of claim 1 wherein each action-value function provides a distribution of action values for a corresponding objective of the plurality of objectives across a range of potential state-action pairs for the previous policy.

15. The method of claim 1 wherein each action-value function outputs an action-value representing the expected cumulative discounted reward for the corresponding objective when choosing a given action in response to a given state.

16. A method for training a neural network system by reinforcement learning, the neural network system being configured to receive an input observation characterizing a state of an environment interacted with by an agent and to select and output an action in accordance with a policy that aims to satisfy a plurality of objectives, the method comprising:
obtaining a set of one or more trajectories, each trajectory comprising a state of an environment, an action applied by the agent to the environment according to a previous policy in response to the state, and a set of rewards for the action, each reward relating to a corresponding objective of the plurality of objectives;
determining a probability distribution for each of the plurality of objectives based on the set of one or more trajectories, each probability distribution providing a distribution of action probabilities that would increase the expected return according to a corresponding objective relative to the policy; and
determining an updated policy based on a combination of the probability distributions for the plurality of objectives.

17. The method of claim 16 wherein:
determining a probability distribution for each of the plurality of objectives comprises, for each objective:
determining a value function defining a value representing an expected return according to the corresponding objective that would result from the agent following the previous policy from a given state; and
determining the probability distribution for the objective based on the value function.

18. The method of claim 17 wherein:
each probability distribution is a state-action distribution defining a distribution of probabilities of state-action pairs and the value function for each objective is a state-value function defining a value representing an expected return according to the corresponding objective that would result from the agent following the previous policy from a given state; or
each probability distribution is an objective-specific policy defining a distribution of probabilities of actions over states and the value function is an action-value function representing an expected return according to the corresponding objective that would result from the agent performing a given action in response to a given state according to the previous policy.

19. A system comprising one or more computers and one or more storage devices storing instructions that when executed by the one or more computers cause the one or more computers to perform operations for training a neural network system by reinforcement learning, the neural network system being configured to receive an input observation characterizing a state of an environment interacted with by an agent and to select and output an action in accordance with a policy that aims to satisfy a plurality of objectives, the method comprising:
obtaining a set of one or more trajectories, each trajectory comprising a state of an environment, an action applied by the agent to the environment according to a previous policy in response to the state, and a set of rewards for the action, each reward relating to a corresponding objective of the plurality of objectives;
determining an action-value function for each of the plurality of objectives based on the set of one or more trajectories, each action-value function determining an action value representing an estimated return according to the corresponding objective that would result from the agent performing a given action in response to a given state according to the previous policy; and
determining an updated policy based on a combination of the action-value functions for the plurality of objectives.

20. (canceled)

21. The system of claim 19 wherein determining an updated policy comprises:
determining an objective-specific policy for each objective in the plurality of objectives, each objective-specific policy being determined based on the corresponding action-value function for the corresponding objective; and
determining the updated policy by fitting a set of policy parameters of the updated policy to a combination of the objective-specific policies.
